(19) United States
(12) Patent Application Publication
(10) Pub. No.: US 2010/0263643 A1
(43) Pub. Date: Oct. 21, 2010

(54) DEVICE FOR MEASURING THE IONIZATION CURRENT IN A RADIO FREQUENCY IGNITION SYSTEM FOR AN INTERNAL COMBUSTION ENGINE

(75) Inventors: Andre Agneray, Boulogne Billancourt (FR); Franck Deloraine, Fontenay aux Roses (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: RENAULT S.A.S., BOULOGNE-BILLANCOURT (FR)

(21) Appl. No.: 12/741,259

(22) PCT Filed: Oct. 1, 2008
(86) PCT No.: PCT/FR08/51776

§ 371 Date: Jun. 23, 2010

(30) Foreign Application Priority Data
Nov. 5, 2007 (FR) 0758795

(51) Int. Cl. F02P 3/01

(52) U.S. Cl. 123/608

(57) ABSTRACT

A radiofrequency ignition device for an internal combustion engine, including: a supply circuit, including a transformer, a secondary winding of which is connected to a resonator including two electrodes configured to generate a spark so as to initiate combustion in a cylinder of the engine upon an ignition command, a measurement capacitor, connected in series between the secondary winding of the transformer and the resonator, and a measurement circuit measuring ionization current of the combustion gases, connected to the measurement capacitor and including a voltage generator with low input impedance, to provide a polarization voltage of the measurement capacitor so as to generate the ionization current, a first amplifier amplifying the ionization current and a measuring mechanism measuring a voltage representative of the amplified ionization current and connected at an output of the first amplifier.

The present invention relates to a measurement device in an electronically-controlled radio frequency ignition system for an internal combustion engine, suitable for measuring of the ionization current of the gases in the cylinders of the engine upon combustion.

The ionization current of the gases in the cylinders of the engine is typically measured after the end of the ignition and is particularly advantageously applicable, for example, for detecting the crankshaft angle corresponding to the pressure peak of the combustion chamber, for detecting pinking or even for identifying misfiring.

Circuits for measuring the ionization current for a conventional ignition system are known, wherein the operation consists in polarizing the mixture in the combustion chamber after the generation of the spark between the electrodes of the sparkplug, in order to measure the current resulting from the propagation of the spark.

Such circuits are conventionally positioned at the foot of the secondary of an ignition coil connected to the sparkplug.

However, these circuits need to be dedicated to the characteristics of conventional ignition and are therefore not suitable as such to plasma generation ignition systems which implement sparkplugs of the radio frequency plug-coil type, as described in detail in the following patent applications filed in the name of the Applicant: FR 03-10766, FR 03-10767 and FR 03-10768.

The specific features of radio frequency ignition engender a number of constraints in measuring the ionization current. In practice, the ionization current is measured after the end of ignition. Its amplitude depends on the DC voltage or “polarization voltage” applied between the high-voltage electrode of the plug and the engine ground. The polarization voltage typically lies between the battery voltage and a few hundred volts. Experience shows that the signal representative of the ionization current has an amplitude of between 0.1 μA and 1 mA depending on the conditions of the combustion chamber (temperature, pressure, composition of the mixture, etc.). Now, the ignition control signal induces significant currents which have an amplitude deviation of almost 120 dB with the ionization current that is to be measured. The measurement circuit therefore undergoes a glare time during which it cannot acquire a low current.

Furthermore, this type of ignition makes it possible to develop 2 types of discharge (a multi-filament spark or a mono-filament arc), which have a different influence on the measurement system. There is therefore difficulty in guaranteeing independence of the measurement of the ionization current relative to the type of discharge generated.

The present invention therefore aims at least partly to resolve these drawbacks by proposing a device for measuring the ionization current that is suited to a radio frequency ignition system.

With this objective in mind, the invention therefore relates to a radio frequency ignition device for an internal combustion engine, characterized in that it comprises:
a power supply circuit, comprising a transformer a secondary winding of which is connected to at least one resonator having a resonance frequency greater than 1 MHz and comprising two electrodes which are able to generate a spark to initiate combustion in a cylinder of the engine upon an ignition command,
a measurement capacitor, connected in series between the secondary winding of the transformer and the resonator, and
a circuit for measuring the ionization current of the combustion gases in the cylinder, connected to said measurement capacitor, said measurement circuit comprising a voltage generator with low input impedance, able to supply a polarization voltage for the measurement capacitor to generate the ionization current, first means of amplifying the ionization current and means of measuring a voltage representative of the amplified ionization current, which are connected to the output of the first amplification means.

Advantageously, the measurement capacitor is connected in series between the secondary winding of the transformer and the resonator, at the level of a ground return wire of the transformer and of the resonator.

According to one embodiment, the measurement circuit comprises a transistor mounted in common base configuration, a first electrode of which is connected to a terminal of the measurement capacitor and a second electrode of which is connected to the polarization voltage via the first amplification means.

According to another embodiment, the first electrode of the transistor mounted in common base configuration is also connected to an input resistor of the measurement circuit.

Advantageously, the means of measuring the voltage representative of the amplified ionization current are also connected to the input resistor via second amplification means, which are able to amplify the current circulating in the input resistor and having an amplification gain identical to the first amplification means.

According to one embodiment, the amplification means comprise a current mirror.

According to one embodiment, the means of measuring the voltage representative of the amplified ionization current comprise a measurement resistor.

According to another embodiment, a primary winding of the transformer is connected on one side to a power supply voltage and on the other side to the drain of at least one switching transistor controlled by a control signal, the switching transistor applying the power supply voltage to the terminals of the primary winding at a frequency defined by the control signal.

Preferably, the transformer has a variable turns ratio.

Other features and benefits of the present invention will become more clearly apparent from reading the following description given by way of illustrative and nonlimiting example and with reference to the appended figures in which:

FIG. 1 is a diagram of a resonator modeling a plasma-generating radio frequency plug coil,

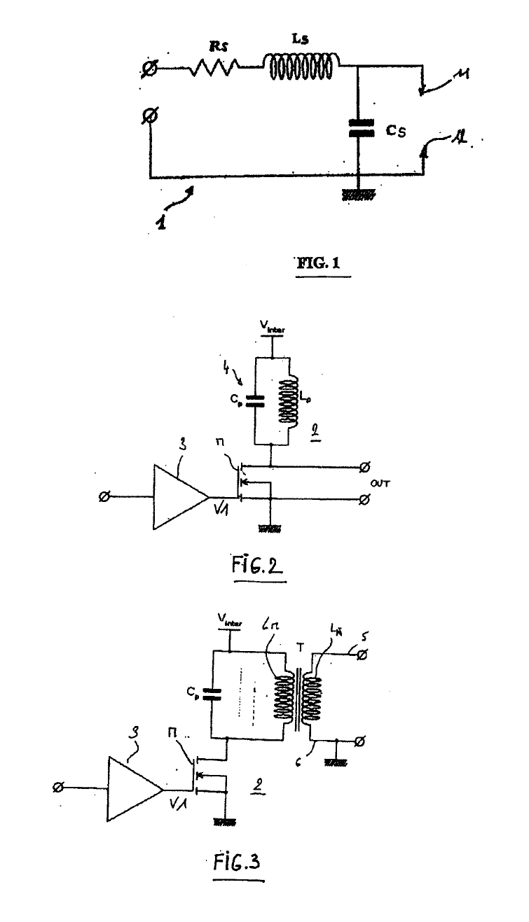

FIG. 2 is a diagram illustrating a power supply circuit according to the state of the art, making it possible to apply an alternating voltage in the radio frequency range to the terminals of the plug coil modeled in FIG. 1,

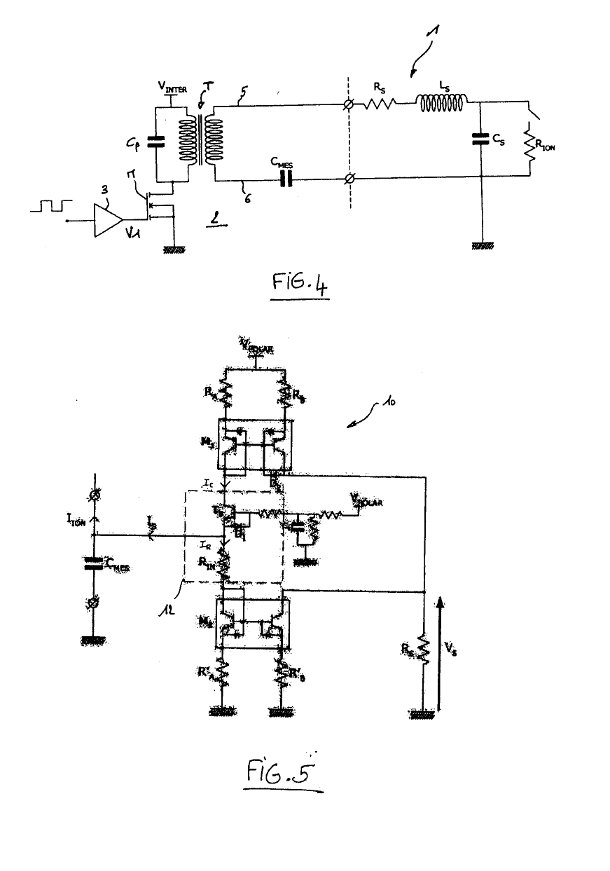

FIG. 3 is a diagram illustrating a variant of the circuit of FIG. 2,

FIG. 4 is a diagram illustrating a power supply circuit adapted according to the invention to measurement of the ionization current, and

FIG. 5 illustrates an embodiment of the ionization current measurement circuit.

The plug coil implemented in the context of controlled radio frequency ignition is electrically equivalent to a resonator 1 (see FIG. 1), the resonance frequency F_{c} of which is greater than 1 MHz, and typically close to 5 MHz. The resonator comprises, in series, a resistor Rs, an inductance coil Ls and a capacitor denoted Cs. Ignition electrodes 11 and 12 of the plug coil are connected to the terminals of the capacitor Cs of the resonator, making it possible to generate multi-filament discharges to initiate combustion of the mixture in the combustion chambers of the engine, when the resonator is powered at its resonance frequency.

In practice, when the resonator is powered by a high voltage at its resonance frequency F_{c} (1/(2π\sqrt{Ls*Cs})), the amplitude at the terminals of the capacitor Cs is amplified so that multi-filament discharges develop between the electrodes, over distances of the order of a centimeter, at high pressure and for peak voltages of less than 20 kV.

The sparks are then said to be “branched”, inasmuch as they involve the simultaneous generation of at least a number of ionization lines or paths in a given volume, their branches also being omnidirectional.

This application to radio frequency ignition then requires the use of a power supply circuit, capable of generating voltage pulses, typically of the order of 100 ns, possibly being able to reach amplitudes of the order of 1 kV, at a frequency very close to the resonance frequency of the plasma generation resonator of the radio frequency plug coil.

FIG. 2 diagrammatically illustrates such a power supply circuit 2, detailed elsewhere in the patent application FR 03-10767. The power supply circuit of the radio frequency plug coil conventionally implements a so-called “pseudo-class E power amplifier” circuit. This circuit makes it possible to create the voltage pulses with the abovementioned characteristics.

This circuit consists of an intermediate DC power supply Vinter that can vary from 0 to 250 V, a power MOSFET transistor M and a parallel resonant circuit 4, comprising a coil Lp in parallel with a capacitor Cp, also with a resonance frequency close to 5 MHz. The transistor M is used as a switch to control the switchings at the terminals of the parallel resonant circuit and of the plasma generation resonator 1 intended for connection to an output interface OUT of the power supply circuit.

The transistor M is driven on its gate by a control logic signal V1, supplied by a control stage 3, at a frequency that should be roughly aligned on the resonance frequency of the resonator 1.

The intermediate DC power supply voltage Vinter, which can vary between 0 and 250 V, can advantageously be supplied by a high-voltage power supply, typically a DC/DC converter.

Thus, in proximity to its resonance frequency, the parallel resonator 4 transforms the DC power supply voltage Vinter into an amplified periodic voltage, corresponding to the power supply voltage multiplied by the quality factor of the parallel resonator and applied to an output interface of the power supply circuit at the level of the drain of the switching transistor M.

The switching transistor M then applies the amplified power supply voltage to the output of the power supply, at the frequency defined by the control signal V1, that is to be made as close as possible to the resonance frequency of the plug coil, so as to generate the high voltage at the terminals of the electrodes of the plug coil that are necessary to the development and sustaining of the multi-filament discharge.

The transistor thus switches high currents (Iₚₑₐₖ≈20 A) at a frequency of approximately 5 MHz, and with a drain-source voltage that can reach 1 kV. The choice of the transistor is therefore critical and necessitates a trade-off between voltage and current.

Also, according to the embodiment illustrated in FIG. 3, it is proposed to replace the parallel coil Lp with a transformer T, having a variable turns ratio, for example of between 1 and 5, and to adapt the turns ratio so as to reduce the drain-source voltage of the switching transistor M. The primary winding L_{M} of the transformer is linked, on one side, to the power supply voltage Vinter and, on the other side, to the drain of the switching transistor M, controlling the application of the power supply voltage Vinter to the terminals of the primary winding at the frequency defined by the control signal V1.

The secondary winding L_{N} of the transformer, one side of which is linked to ground by a ground return wire 6, is designed to be connected to the plug coil. In this way, the resonator 1 of the plug coil, connected to the terminals of the secondary winding by link wires 5 and 6, including the ground return wire 6, is therefore powered by the secondary of the transformer, as illustrated in FIG. 4.

Adapting the turns ratio then makes it possible to reduce the drain-source voltage of the transistor. Reducing the voltage on the primary however induces an increase in the current passing through the transistor. It is then possible to compensate this constraint by, for example, placing two transistors in parallel controlled by the same control stage 3.

Upon ignition, it is essential for the branched spark to develop in volume in order to ensure combustion and optimum engine operation. Measuring of the ionization current therefore entails using a component which does not degrade the energy efficiency of the ignition.

The solution retained for this purpose consists in connecting a measurement capacitor C_{MES} in series between the secondary winding of the transformer T and the resonator 1, to the ground return wire 6. The measurement capacitor is thus advantageously placed in the circuit at a point where the potential differences relative to ground are as low as possible.

A capacitor of reduced capacitance, typically around ten nanofarads, makes it possible not to disturb the ignition system while having the possibility of performing low-frequency measurements of the ionization current.

Thus, the main benefit from the choice of this measurement component over other passive components lies in its radio frequency behavior. In practice, at high frequencies, those skilled in the art know that the high-frequency equivalent circuit of a capacitor consists of a series resonator. Now, a resonator has an impedance that changes according to the frequency of the signal applied to its input, and is minimal at the resonance frequency of the resonator. This characteristic of the change in impedance of a resonator as a function of the frequency then enables the capacitor to present a very low impedance in the vicinity of the ignition resonance frequency and a high impedance in the frequency band used for the ionization signal (F_{ION}<15 kHz). The measurement capacitor is therefore judiciously chosen so as to present its lowest impedance in the range of frequencies used for the ignition control signal. This makes it possible to minimize the voltage at the terminals of the measurement capacitor to protect the measurement circuit, which will now be described with reference to FIG. 5.

Useful combustion information can be extracted from the ionic signal soon after the end of ignition. With the combustion lasting on average 40° crankshaft, it is tolerable for the information to be masked for up to 200 μs after the end of the spark (or approximately 8° crankshaft for an engine speed of 6500 rpm). It is then necessary to provide a measurement circuit that is able to be available very rapidly to perform the measurement. Since the measurement circuit is saturated throughout the ignition phase, because of the major currents induced by the ignition control signal, it is then necessary for the circuit desaturation time to be no more than 200 μs in order to be able to acquire the measurement signal in linear mode.

Also, the measurement circuit 10, connected to the terminals of the measurement capacitor C_{MES}, as illustrated in FIG. 5, advantageously comprises a voltage generator with low input impedance, typically of the order of around 10 ohms, so as to reduce the glare time of the measurement circuit, and able to supply a DC polarization voltage V_{POLAR} to charge the measurement capacitor C_{MES}. The voltage V_{POLAR} can, for example, be between 12 and 250 V.

Thus, the low input impedance of the generator makes it possible to keep the voltage constant at the terminals of the capacitor and/or rapidly bring its voltage to V_{POLAR} after the spark. This impedance is sufficiently low for the current I_{ION} representative of the trend of the combustion of the gases in the combustion chamber to be supplied by the transistor T_{B}, the operation of which will be described in more detail hereinbelow, and not by the capacitor C. It is this discharge current I_{ION} that is to be measured via the measurement circuit 10 of FIG. 5.

Thus, the polarization voltage V_{POLAR} is applied to the circuit via a polarization stage 12, comprising a bipolar transistor T_{B} mounted in common base configuration with an output on the emitter of the transistor, connected to a terminal of the measurement capacitor C_{MES}. The mounting of the transistor T_{B} in common base configuration is characterized notably by its low input impedance, advantageously making it possible to obtain the desired reactivity on the measurement circuit.

For example, by connecting this circuit to the measurement capacitor, an input impedance Z_{E} is obtained that is equivalent to:

$${Z}_{E} = {R}_{IN} / ( \frac{{r}_{be}}{β + 1} )$$

In which: R_{IN} is the resistor placed at the input of the measurement circuit,
R_{be} indicates the intrinsic resistance of the transistor TB, and
β corresponds to the gain of the transistor TB.
Typically, by choosing: R_{IN}=8 kΩ, R_{be}=1 kΩ and β=100, we obtain Z_{E}≈10Ω.

The output current I_{S} of the circuit 12, representative of the ionization current I_{ION}, is measured via the output resistor R_{S} of the measurement circuit which, as will be seen in more detail hereinbelow, is in fact passed through by a current which confers on it a voltage V_{S} at its terminals, the measurement of which will then provide an image in voltage of the ionization current.

This current I_{S} is roughly equal to the current difference between the current I_{c} entering into the transistor T_{B} and the current Iₚ circulating in the circuit's input resistor R_{IN}.

Now, since the amplitude of the ionization current that is to be measured is low and mostly less than 1 mA, the measurement circuit advantageously comprises current amplification means. To this end, the measurement circuit comprises a first current mirror M₁, connected between the polarization voltage source V_{POLAR} and the input of the transistor T_{B}, and having an amplification gain Gₘ=R_{A}/R_{B}, defined by the values of the resistors R_{A} and R_{B} respectively present in each branch of the current mirror M₁. The current mirror M₁ therefore makes it possible to amplify the current of the signal I_{c} entering into the transistor T_{B}, to copy this amplified signal intended for the resistor R_{S}, connected to the output of the current mirror M₁.

As has been seen, the current I_{c} is the sum of the ionization current I_{ION} and the current I_{R} circulating in the input resistor R_{IN}. Also, in order to measure a voltage V_{S} at the terminals of R_{S} that is representative of the only ionization current, it is necessary to subtract the unwanted component corresponding to the current circulating in the input resistor R_{IN} from the amplified signal obtained at the output of the current mirror M₁.

To do this, the measurement circuit comprises a second current mirror M₂, connected between the input resistor R_{IN} of the circuit and ground, and having an amplification gain Gₘ that is identical to the first current mirror M₁, defined by the values of the resistors R′_{A} and R′_{B} respectively present in each branch of the current mirror M₂.

The output resistor R_{S}, connected to the output of the second amplification means M₂, is therefore passed through by the current difference I_{c}−I_{R}, roughly equal to the ionization current I_{ION}, amplified by the ratio Gₘ=R_{A}/R_{B}=R′_{A}/R′_{B}. In other words, the output resistor R_{S} is passed through by an amplified image of the ionization current, so as to obtain the output voltage V_{S} at its terminals according to the relation:

V_{S}=Gₘ×R_{S}×I_{ION}
In which: Gₘ is the gain of the current mirror,
R_{S} is the output resistor, and
I_{ION} corresponds to the ionization current.

In order to obtain a high ionization current, the circuit must be polarized with a DC voltage that is as high as possible, but limited by the maximum voltages and currents supported by the transistors of the circuit. Also, the maximum voltage accepted by the transistors of the measurement circuit determines the polarization voltage of the circuit. Similarly, the input current must remain sufficiently low to guarantee linear-mode operation. This constraint conditions the gain applied to the current mirrors. Thus, in the case of a short circuit on the input (on the terminals of the measurement capacitor), the current increases in the resistor R_{A} of the current mirror M₁. By amplification, the current in the resistor R_{B} is increased. To protect the circuit, it is possible to add a diode D₂ from the collector to the base of the second transistor of the current mirror M₁.

It will also be observed that the voltage at the terminals of the measurement capacitor is also a function of the type of spark generated. A mono-filament spark between the electrode of the plug and a ground plan leads to an abrupt increase in the current circulating in the measurement capacitor and consequently a high variation of the voltage at its terminals, potentially damaging for the measurement circuit. The measurement circuit can therefore provide a protection diode D₁, making it possible to transfer the excess energy into a buffer capacitor C_{T} and ensure that the voltage at the terminals of the measurement capacitor does not exceed the polarization voltage V_{POLAR}.

1-9. (canceled)

10. A radio frequency ignition device for an internal combustion engine, comprising:
a power supply circuit, comprising a transformer including a secondary winding connected to at least one resonator having a resonance frequency greater than 1 MHz and comprising two electrodes configured to generate a spark to initiate combustion in a cylinder of the engine upon an ignition command;
a measurement capacitor, connected in series between the secondary winding of the transformer and the resonator; and
a circuit measuring ionization current of the combustion gases in the cylinder, connected to the measurement capacitor, the measurement circuit comprising a voltage generator with low input impedance, configured to supply a polarization voltage for the measurement capacitor to generate the ionization current, first means for amplifying the ionization current, and means for measuring a voltage representative of the amplified ionization current, which is connected to an output of the first amplification means.

11. The device as claimed in claim 10, wherein the measurement capacitor is connected in series between the secondary winding of the transformer and the resonator, at a level of a ground return wire of the transformer and of the resonator.

12. The device as claimed in claim 10, wherein the measurement circuit comprises a transistor mounted in common base configuration, a first electrode of which is connected to a terminal of the measurement capacitor and a second electrode of which is connected to the polarization voltage via the first amplification means.

13. The device as claimed in claim 12, wherein the first electrode of the transistor mounted in common base configuration is also connected to an input resistor of the measurement circuit.

14. The device as claimed in claim 13, wherein the means for measuring the voltage representative of the amplified ionization current is also connected to the input resistor via second amplification means, which is configured to amplify the current circulating in the input resistor and having an amplification gain identical to the first amplification means.

15. The device as claimed in claim 10, wherein the amplification means comprises a current mirror.

16. The device as claimed in claim 10, wherein the means for measuring the voltage representative of the amplified ionization current comprises a measurement resistor.

17. The device as claimed in claim 10, wherein a primary winding of the transformer is connected on one side to a power supply voltage and on another side to a drain of at least one switching transistor controlled by a control signal, the switching transistor applying the power supply voltage to terminals of the primary winding at a frequency defined by the control signal.

18. The device as claimed in claim 10, wherein the transformer has a variable turns ratio.
